(19) United States
(12) Patent Application Publication
(10) Pub. No.: US 2014/0281105 A1
(43) Pub. Date: Sep. 18, 2014

(54) HIGH SPEED DISK ARRAY SPIDER CABLE

(71) Applicant: Silicon Graphics International Corp., Fremont, CA (US)

(72) Inventors: Jim Joseph Brewer, Longmont, CO (US); Jay Everett Nelson, Superior, CO (US)

(21) Appl. No.: 13/931,793

(22) Filed: Jun. 28, 2013

Related U.S. Application Data
(60) Provisional application No. 61/786,426, filed on Mar. 15, 2013.

(51) Int. Cl. G06F 13/40

(52) U.S. Cl. CPC G06F 13/4027
USPC 710/312

(57) ABSTRACT

Embodiments of the invention includes a plurality of connectors configured to connect a plurality of data storage host bus adaptors to a plurality of data storage device subassemblies such that at least one lane of low voltage differential signal pairs from each of the plurality of host bus adaptors is connected to each of the data storage device subassemblies. The invention improves the electrical interconnections in a data storage array such as a JBOD enclosure or data storage server. The invention minimizes the number of connectors by reducing the number of printed circuit boards, and eliminates the need to add signal repeaters to maintain signal quality. The invention also increases the cooling efficiency of the enclosure by increasing air flow by reducing the number of printed circuit boards in the data storage array.

### CROSS REFERENCE TO RELATED APPLICATIONS

The present application claims the priority benefit of U.S. provisional application No. 61/786,426 filed Mar. 14, 2013 and entitled “High Speed Disk Array Spider Cable,” the disclosure of which is incorporated herein by reference.

### BACKGROUND OF THE INVENTION

1. Field of the Invention

The present invention generally relates to cables and a cabling system engineered to maximize the packaging density of data storage devices in an enclosure.

2. Description of the Related Art

The modern data center contains a plurality of heterogeneous types of data storage equipment. Frequently, an array of data storage devices configured along with various printed circuit boards are packaged within an enclosure forming a high density data storage server. Such enclosures are boxes data storage arrays commonly referred to as Just a Bunch of Disks (JBOD) or data storage servers. Frequently, JBOD boxes or data storage servers contain printed circuit boards configured as data storage host bus adaptors (controllers) or port expanders. Data storage host bus adaptors are typically configured to control data storage devices and port expanders are typically configured as switches that may switch several sets communication signals from one data storage device to another.

The most common data storage device communication signals used in the data center today are low voltage differential signals configured in a plurality of pairs. Standard data storage device communication interfaces include serial attached SCSI (SAS) and serial attached ATA (SATA).

Both SAS and SATA communication interfaces contain two pairs of electrical conductors. One pair of these conductors is configured to transmit commands and data to a data storage device and the second pair of conductors is configured to receive data or other information from that same data storage device. Each set of two pairs of electrical conductors is commonly referred to as a data communication lane. The electrical conductors for each lane are commonly referred to as transmit X (TrX), transmit Y (TrY), read X (RdX), and read Y (RdY).

Frequently, data storage arrays have several circuit boards and a plurality of cables interconnecting those circuit boards. Typically host bus adaptors are circuit boards that connect devices external to the data storage array to circuit boards inside of the JBOD enclosure. Circuit boards internal to data storage arrays also include mid-plane boards configured to fan out (spread out) data storage device communication interface signals, and port expanders that are typically configured to switch data communication signals to individual data storage devices.

Thus, data storage arrays contain many circuit boards with a plurality of cables connecting the different circuit boards electrically to each other and to a plurality of data storage devices. This means that the typical data storage array contains many connectors to which the cables connect. Each time a low voltage differential signal pair goes through a connector, the quality of that signal reduces. Furthermore, signal quality is reduced when transmitting signals over long distances through printed circuit boards. This causes designers of JBOD boxes to incorporate repeater electronics into their designs or to use dozens of cables. Furthermore, each circuit board in a data storage array obstructs airflow through the box. Insufficient airflow in a data storage array may increase the failure rate of data storage devices contained within the data storage array.

Factors that affect signal quality include conductor (trace) impedance, signal frequency, conductor (trace) length, conductor cross sectional area, the distance from a conductor to ground, and the number of connectors that a signal goes through. Typically, as signal frequency increases, signal quality reduces for a given conductor length. Thus, as signal frequency increases, the maximum effective conductor length reduces.

What is needed are improved electrical interconnections that minimize the number of connectors, repeaters, and circuit boards used in a data storage array.

### SUMMARY OF THE INVENTION

An embodiment of the invention includes a plurality of connectors configured to connect a plurality of data storage host bus adaptors to a plurality of data storage device subassemblies. In one such embodiment, a connector on each host bus adaptor is configured to contain 4 data communication lanes. Since each data communication lane contains 4 signals, the host bus adaptor's connector would contain at least 16 electrical connections capable of transporting low voltage differential signals in 8 pairs.

Such a high speed data storage crossover cable consistent with the invention could be configured to route at least one of the data communication lanes from a first host bus adaptor to four separate data storage device subassemblies through various connectors. Furthermore, such an embodiment could contain a second, third, and a fourth host bus adaptor. If each host bus adaptor contained 4 data communication lanes routed to each of the four separate data storage device subassemblies, then each of the four host bus adaptors could communicate with each of the four different data storage device subassemblies.

Another example includes the instance where each data storage device subassembly contains as many as 18 disk drives and each JBOD enclosure contains as many as 9 data storage device subassemblies. The JBOD enclosure could then contain as many as 162 disk drives that could be controlled by a plurality of different host bus adaptors.

The invention thus relates to a high speed data storage crossover cable where a plurality of individual data storage host bus adaptors can communicate with a plurality of different data storage subassemblies each containing a plurality of data storage devices.

The invention also relates to maximizing packaging density of data storage devices in an enclosure. Cables consistent with the invention enable more data storage devices to be built into a JBOD enclosure of a particular size while allowing sufficient air flow to cool those data storage devices.

The invention thus improves the electrical interconnections in a JBOD enclosure, minimizes the number of connectors by reducing the number of printed circuit boards, and eliminates the need to add signal repeaters to maintain signal quality.

### BRIEF DESCRIPTION OF THE DRAWINGS

FIG. 1 illustrates a crossover cable consistent with the invention.

FIG. 2 illustrates a second crossover cable consistent with the invention.

FIG. 3 illustrates data communication lanes crossing from 4 different host bus adaptor connectors to each of 4 different data storage device subassembly connectors.

FIG. 4 illustrates a simplified conventional data storage array.

FIG. 5 is a simplified data storage array containing a cross over cable.

### DETAILED DESCRIPTION

An embodiment of the invention includes a plurality of connectors configured to connect a plurality of data storage host bus adaptors to a plurality of data storage device subassemblies. In one such embodiment, a connector on each host bus adaptor is configured to contain 4 data communication lanes. Since each data communication lane contains 4 signals, the host bus adaptor's connector would contain at least 16 electrical connections capable of transporting low voltage differential signals in 8 pairs.

Such a high speed data storage crossover cable consistent with the invention could be configured to route at least one of the data communication lanes from a first host bus adaptor to four separate data storage device subassemblies through various connectors. Furthermore, such an embodiment could contain a second, third, and a fourth host bus adaptor. If each host bus adaptor contained 4 data communication lanes routed to each of the four separate data storage device subassemblies, then each of the four host bus adaptors could communicate with each of the four different data storage device subassemblies.

Another example includes the instance where each data storage device subassembly contains as many as 18 disk drives and each JBOD enclosure contains as many as 9 data storage device subassemblies. The JBOD enclosure could then contain as many as 162 disk drives that could be controlled by a plurality of different host bus adaptors.

The invention thus relates to a high speed data storage crossover cable where a plurality of individual data storage host bus adaptors can communicate with a plurality of different data storage subassemblies each containing a plurality of data storage devices.

FIG. 1 illustrates a crossover cable consistent with the invention. FIG. 1 shows a Cross Over A cable containing a plurality of connectors configured to connect to a plurality of different host bus adaptors. Here connector P1A is configured to connect to a first host bus adapter, connector P2A is configured to connect to a second host bus adapter, connector P3A is configured to connect to a third host bus adapter, and connector P4A is configured to connect to a fourth host bus adapter. Each host bus adaptor connector P1A, P2A, P3A, and P4A are configured to contain 4 lanes of low voltage differential signals. The center portion of the figure identified as Cross Over A is where lanes from each host bus adaptor connectors P1A, P2A, P3A, and P4A are crossed over to a plurality of data storage device subassembly connectors P5A, P6A, P7A, and P8A. In certain embodiments of the invention, each data storage device subassembly contains a port expander configured to switch data communication signals to any one of a plurality of data storage devices. In such a JBOD enclosure containing 9 data storage device subassemblies where each such a subassembly contains 18 disk drives, each of the four host bus adaptors could be configured to control any one of 162 disk drives.

FIG. 2 illustrates a second crossover cable consistent with the invention.

FIG. 2 shows a Cross Over B cable containing a plurality of connectors configured to connect to the same plurality of different host bus adaptors discussed in FIG. 1. Here, connector P1B is configured to connect to a second port of the first host bus adaptor, connector P2B is configured to connect to a second port of the second host bus adapter, connector P3B is configured to connect to a second port of the third host bus adapter, and connector P4B is configured to connect to a second port of the fourth host bus adapter. Each host bus adaptor connector P1B, P2B, P3B, and P4B are configured to contain 4 lanes of low voltage differential signals. The center portion of the figure identified as Cross Over B is where lanes from each host bus adaptor connectors P1B, P2B, P3B, and P4B are crossed over to a plurality of data storage device subassembly connectors P5B, P6B, P7B, and P8B. In certain embodiments of the invention, each data storage device subassembly contains a port expander configured to switch data communication signals to any one of a plurality of data storage devices. In such a JBOD enclosure containing two crossover cables connected to 4 host bus adaptors, and configured to connect to 8 data storage device subassemblies where each data storage device subassembly contains up to 18 disk drives, each of the 4 host bus adaptors could be configured to control any one of 144 disk drives.

FIG. 3 illustrates data communication lanes crossing from 4 different host bus adaptor connectors to each of 4 different data storage device subassembly connectors.

FIG. 3 shows 4 data communication lanes from a first host bus adaptor connector P1 crossing over to 4 different data storage device sub assembly connectors P5, P6, P7, and P8. Similarly, FIG. 3 shows 4 data communication lanes from host bus adaptor connectors P2, P3, and P4 also crossing over to 4 different data storage device subassembly connectors P5, P6, P7, and P8.

More specifically FIG. 3 shows connector P1 connecting a first lane of data communication signal pairs with conductors labeled RdX0, RdY0, TrX0, and TrY0. Connector P1 connects this first lane of data communication signals to connector P8 where connector P1 pins B17, B16, A17, and A16 connect to P8 pins A3, A2, B3, B2 respectively using conductor lengths that are 44 inches long.

Connector P1 also connects a second lane of data communication signals to connector P7 using conductor lengths that are 40 inches long, a third lane of data communication signals to connector P6 using conductor lengths that are 36 inches long, and a fourth lane of data communication signals to connector P5 conductor lengths that are 40 inches long. Each subsequent lane of data communication signals contain low voltage differential signal read pair, and a write pair assigned a different lane number. For example the second lane of data communication signals include conductors RdX1, RdY1, TrX1, and TrY1; there are a total of 16 lanes (lanes 0 to 15) of data communication signals are depicted in FIG. 3.

Each individual conductor depicted in FIG. 3 is connected to a specific pair of connector pins. For example conductors RdX15, RdY15, TrX15, and TrY15 are connected from connector P4 pins B3, B2, A3, and A4 to connector P5 pins A12, A11, B12, and B11 respectively. For clarity ground connections are not depicted in FIG. 3.

The invention also relates to maximizing packaging density of data storage devices in an enclosure. Cables consistent with the invention enable more data storage devices to be built into a JBOD enclosure of a particular size while allowing sufficient air flow to cool those data storage devices. The crossover cable eliminates the need for bulky circuit boards configured to fan out (spread out) data storage device communication interface signals to a plurality of data storage devices or data storage device subassemblies.

FIG. 4 illustrates a simplified conventional data storage array. FIG. 4 depicts a Semi-Cross Sectional Side View and a Semi-Cross Sectional Top view of a conventional data storage array DSA. The data storage array DSA of FIG. 4 includes fans F, four host bus adaptors (HBA0, HBA1, HBA2, and HBA3), four data storage subassemblies (DSS0, DSS1, DSS2, DSS3), a plurality of cables C, and a mid-plane circuit board M. FIG. 4 is simplified, the figure does not show all elements that may be included in a data storage array, such as power supplies, input/output connection boards, or computer boards commonly used in data storage array servers.

Each host bus adapter (HBA0, HBA1, HBA2, and HBA3) is connected to the mid-plane circuit board M with cables C, and the mid-plane circuit board M is connected to data storage sub-assemblies (DSS0, DSS1, DSS2, DSS3) with additional cables C. The mid-plane circuit board M and cables C connect at least one lane of data communication signals from each host bus adapter (HBA0, HBA1, HBA2, and HBA3) to each data storage array (DSS0, DSS1, DSS2, DSS3).

The mid-plane circuit board in conventional designs obstruct air flow (not depicted) from fans F through the data storage array DSA. Because typical data storage arrays are contain a high density of data storage subassemblies, printed circuit boards, and power supplies mid-plane boards are frequently placed where they fit in rather than being placed in locations where air flow is optimized.

FIG. 5 is a simplified data storage array containing a cross over cable. FIG. 5 depicts a Semi-Cross Sectional Side View and a Semi-Cross Sectional Top view of a data storage array DSA without the mid-plane circuit board M of FIG. 4. The data storage array DSA of FIG. 5 includes many of the same elements contained in FIG. 4: fans F, four host bus adaptors (HBA0, HBA1, HBA2, and HBA3), and four data storage subassemblies (DSS0, DSS1, DSS2, DSS3), a plurality of cables C, and a mid-plane circuit board M. Here, however the cross over cable COC has replaced the mid-plane circuit board M of FIG. 4. thus improving air flow (not depicted) through the data storage array DSA.

Each host bus adapter (HBA0, HBA1, HBA2, and HBA3) is connected to the cross over cable COC, and the cross over cable COC is connected to data storage sub-assemblies (DSS0, DSS1, DSS2, DSS3). The cross over cable COC connects at least one lane of data communication signals from each host bus adapter (HBA0, HBA1, HBA2, and HBA3) to each data storage array (DSS0, DSS1, DSS2, DSS3).

The invention thus improves the electrical interconnections in a data storage array (JBOD enclosure, or data storage server) by reducing the total number of connectors. Instead of one cable from each host bus adapter to the mid-plane board, and one cable from each data storage subassembly to the mid-plane board the cross over cable eliminates a plurality of connectors. The data storage array in FIG. 4 requires 8 cables with 16 connectors, where the data storage array in FIG. 5 requires 1 cable with 8 connectors. The cross over cable eliminates the potential need to add signal repeaters to maintain signal quality, and increases the cooling efficiency of the enclosure by increasing air flow.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A high speed data storage crossover cable comprising:
a first connector containing a plurality of signal pairs configured to provide at least one lane of low voltage differential signal pairs from a first circuit board to a first plurality of data storage device subassemblies through a plurality of data storage device connectors; and
a second connector containing a plurality of signal pairs configured to provide at least one lane of low voltage differential signal pairs from a second circuit board to the first plurality the data storage device subassemblies through the plurality of data storage device connectors.

2. The high speed data storage crossover cable of claim 1, further comprising:
a third connector containing a plurality of signal pairs configured to provide at least one lane of low voltage differential signal pairs from a third circuit board to the first plurality of data storage device subassemblies through the plurality of data storage device connectors; and
a fourth connector containing a plurality of signal pairs configured to provide at least one lane of low voltage differential signal pairs from a fourth circuit board to the first plurality data storage device subassemblies through the plurality of data storage device connectors.

3. A first high speed data storage crossover cable of claim 2 wherein the first circuit board is a data storage device host bus adaptor, and the first plurality of data storage device subassemblies are electrically connected to the first circuit board through the first high speed data storage crossover cable.

4. The first high speed data storage crossover cable of claim 3 wherein the second circuit board is a data storage device host bus adaptor, and the first plurality of data storage device subassemblies are electrically connected to the second circuit board through the first high speed data storage crossover cable.

5. The first high speed data storage crossover cable of claim 4 wherein the third circuit board is a data storage device host bus adaptor, and the first plurality of data storage device subassemblies are electrically connected to the third circuit board through the first high speed data storage crossover cable.

6. The first high speed data storage crossover cable of claim 5 wherein the fourth circuit board is a data storage device host bus adaptor, and the plurality of data storage device subassemblies are electrically connected to the fourth circuit board through the high speed data storage crossover cable.

7. The high speed data storage crossover cable of claim 6 and the first plurality of data storage device subassemblies are contained within an enclosure forming a data storage array.

8. The data storage device subassemblies of claim 7 further comprising a plurality of data storage devices in each of the individual data storage device subassemblies.

9. The data storage device subassemblies of claim 8 further comprising a port expander in each of the individual data storage device subassemblies.

10. The data storage array of claim 7 further comprising a second high speed crossover cable and wherein the first, second, third, and fourth circuit boards are data storage device host bus adaptors, and the first plurality of data storage device subassemblies or a second plurality of data storage device subassemblies are electrically connected to the first, second, third, and fourth circuit boards through the first high speed data storage crossover cable or through the second high speed data storage crossover cable.

11. The data storage device subassemblies of claim 10 further comprising a plurality of data storage devices in each of the individual data storage device subassemblies.

12. The data storage device subassemblies of claim 11 further comprising a port expander in each of the individual data storage device subassemblies.
